(19) United States
(12) Patent Application Publication
(10) Pub. No.: US 2016/0210570 A1
(43) Pub. Date: Jul. 21, 2016

(54) METHODS AND SYSTEMS FOR RECOMMENDING TASKS

(71) Applicant: XEROX CORPORATION, Norwalk, CT (US)

(72) Inventors: HAENGJU LEE, Webster, NY (US); GUANGYU ZOU, Webster, NY (US); David R. Vandervort, Walworth, NY (US)

(21) Appl. No.: 14/597,330

(22) Filed: Jan. 15, 2015

(51) Int. Cl. G06Q 10/06

(52) U.S. Cl. CPC G06Q 10/06311; G06Q 50/01

(57) ABSTRACT

According to embodiments illustrated herein, there is provided a method for recommending one or more first tasks to one or more workers. The method includes determining a first score for a count of transactions, a second score for each of one or more locations based on a result of one or more second tasks in each of the one or more locations, and a third score for each of one or more industries based on a result of the one or more second tasks in each of the one or more industries. The method further includes ranking the one or more first tasks based on at least the first score, the second score, the third score, and one or more attributes associated with the one or more first tasks. Thereafter, the ranked one or more first tasks are presented to the one or more workers.

### TECHNICAL FIELD

The presently disclosed embodiments are related, in general, to crowdsourcing. More particularly, the presently disclosed embodiments are related to methods and systems for recommending one or more tasks to one or more workers.

### BACKGROUND

Crowdsourcing is a process of obtaining needed services, ideas, or content by soliciting contributions from a large group of people, and especially from an online community, rather than from traditional employees or suppliers. This large group of people is commonly referred to as crowd workers. Crowdsourcing may enable scaling of business processes by outsourcing to a wide and diverse crowd. The requesters may crowdsource various tasks related to the digitization of documents, image tagging, language translation, etc.

Outreach tasks are another type of tasks that are being crowdsourced by the requesters. Outreach job refer to a job in which a worker may reach out to a potential customer of an organization. The organization may offer product/services to the potential customer.

The current outreach crowdsourcing system may recommend tasks to one or more workers based on financial incentive associated with the tasks. The probability of success of the tasks may not be considered while recommending the tasks to the one or more workers. The current way of recommending the tasks may disregard the previous success/performance of the one or more workers on previously attempted tasks. Such recommendation of the tasks may be undesirable for the one or more workers.

### SUMMARY

According to embodiments illustrated herein, there is provided a method for recommending one or more first tasks to one or more workers. The method includes obtaining, by one or more processors, historical data pertaining to execution of one or more second tasks associated with a crowdsourcing platform. The historical data comprises at least, but not limited to, a result of the one or more second tasks, one or more industries associated with the one or more second tasks, a count of transactions between the one or more industries and one or more customers associated with the one or more industries, and one or more locations of the one or more industries. The method further includes determining, by an arithmetic logic unit in one or more processors, a first score for the count of transactions between the one or more industries and the one or more customers based on the result of the one or more second tasks. The method further includes determining, by arithmetic logic unit in one or more processors, a second score for each of the one or more locations based on the result of the one or more second tasks in each of the one or more locations. The method further includes determining, by arithmetic logic unit in one or more processors, a third score for each of the one or more industries based on the result of the one or more second tasks in each of the one or more industries. The method further includes ranking, by one or more processors, the one or more first tasks based on at least the first score, the second score, the third score, and one or more attributes associated with the one or more first tasks, wherein the ranked one or more first tasks are presented to the one or more workers. The method is performed by one or more processors.

According to embodiments illustrated herein, there is provided a method for recommending one or more first tasks to a worker. The method includes obtaining, by one or more processors, historical data pertaining to execution of one or more second tasks associated with the worker. The historical data comprises at least, but not limited to, a result of the one or more second tasks, one or more industries associated with the one or more second tasks, a count of transactions between the one or more industries and one or more customers associated with the one or more industries, and one or more locations of the one or more industries. The method further includes determining, by an arithmetic logic unit in one or more processors, a first score for the count of transactions between the one or more industries and the one or more customers based on the result of the one or more second tasks. The method further includes determining, by arithmetic logic unit in one or more processors, a second score for each of the one or more locations based on the result of the one or more second tasks in each of the one or more locations. The method further includes determining, by arithmetic logic unit in one or more processors, a third score for each of the one or more industries based on the result of the one or more second tasks in each of the one or more industries. The method further includes ranking, by one or more processors, the one or more first tasks based on at least the first score, the second score, the third score, and one or more attributes associated with the one or more first tasks, wherein the ranked one or more first tasks are presented to the worker. The method is performed by one or more processors.

According to embodiments illustrated herein, there is provided a system for recommending one or more first tasks to one or more workers. The system includes one or more processors configured to obtain historical data pertaining to execution of one or more second tasks associated with a crowdsourcing platform. The historical data comprises at least, but not limited to, a result of the one or more second tasks, one or more industries associated with the one or more second tasks, a count of transactions between the one or more industries and one or more customers associated with the one or more industries, and one or more locations of the one or more industries. The system includes an arithmetic logic unit in the one or more processors configured to determine a first score for the count of transactions between the one or more industries and the one or more customers based on the result of the one or more second tasks. The arithmetic logic unit in the one or more processors are further configured to determine a second score for each of the one or more locations based on the result of the one or more second tasks in each of the one or more locations. The arithmetic logic unit in the one or more processors are further configured to determine a third score for each of the one or more industries based on the result of the one or more second tasks for each of the one or more industries. The arithmetic logic unit in the one or more processors are further configured to determine a fourth score for the crowdsourcing platform based on a number of successful tasks, and a number of unsuccessful tasks associated with the crowdsourcing platform. The arithmetic logic unit in the one or more processors are further configured to determine a fifth score for the one or more first tasks based on at least the first score, the second score, the third score, the fourth score, and one or more attributes associated with said one or more first tasks. The arithmetic logic unit in the one or more processors are further configured to determine a rank score for the one or more first tasks based on at least the fifth score and the count of transactions between the one or more industries and the one or more customers associated with the one or more industries. The one or more processors are further configured to rank the one or more first tasks based on the rank score, wherein the ranked one or more first tasks are presented to the one or more workers.

According to embodiments illustrated herein, there is provided a computer program product for use with a computer. The computer program product includes a non-transitory computer readable medium. The non-transitory computer readable medium stores a computer program code for recommending one or more first tasks to one or more workers. The computer program code is executable by one or more processors to obtain historical data pertaining to execution of one or more second tasks associated with a crowdsourcing platform. The historical data comprises at least, but not limited to, a result of the one or more second tasks, one or more industries associated with the one or more second tasks, a count of transactions between the one or more industries and one or more customers associated with the one or more industries, and one or more locations of the one or more industries. The computer program code is further executable by an arithmetic logic unit in the one or more processors configured to determine a first score for the count of transactions between the one or more industries and the one or more customers based on the result of the one or more second tasks. The computer program code is further executable by the arithmetic logic unit in the one or more processors are further configured to determine a second score for each of the one or more locations based on the result of the one or more second tasks in each of the one or more locations. The computer program code is further executable by the arithmetic logic unit in the one or more processors configured to determine a third score for each of the one or more industries based on the result of the one or more second tasks for each of the one or more industries. The computer program code is further executable by the arithmetic logic unit in the one or more processors configured to determine a fourth score for the crowdsourcing platform based on a number of successful tasks, and a number of unsuccessful tasks associated with the crowdsourcing platform. The computer program code is further executable by the arithmetic logic unit in the one or more processors configured to determine a fifth score for the one or more first tasks based on at least the first score, the second score, the third score, the fourth score, and one or more attributes associated with said one or more first tasks. The computer program code is further executable by the arithmetic logic unit in the one or more processors configured to determine a rank score for the one or more first tasks based on at least the fifth score and the count of transactions between the one or more industries and the one or more customers associated with the one or more industries. The computer program code is further executable by the one or more processors configured to rank the one or more first tasks based on the rank score, wherein the ranked one or more first tasks are presented to the one or more workers.

### BRIEF DESCRIPTION OF DRAWINGS

The accompanying drawings illustrate various embodiments of systems, methods, and other aspects of the disclosure. Any person having ordinary skill in the art will appreciate that the illustrated element boundaries (e.g., boxes, groups of boxes, or other shapes) in the figures represent one example of the boundaries. It may be that in some examples, one element may be designed as multiple elements or that multiple elements may be designed as one element. In some examples, an element shown as an internal component of one element may be implemented as an external component in another, and vice versa. Furthermore, elements may not be drawn to scale.

Various embodiments will hereinafter be described in accordance with the appended drawings, which are provided to illustrate, and not to limit the scope in any manner, wherein like designations denote similar elements, and in which:

FIG. 1 is a block diagram illustrating a system environment in which various embodiments may be implemented;

FIG. 2 is a block diagram illustrating a system for recommending one or more first tasks to one or more workers, in accordance with at least one embodiment;

FIG. 3 is a flowchart illustrating a method for recommending one or more first tasks to one or more workers on a crowdsourcing platform, in accordance with at least one embodiment;

FIG. 4 is a flowchart illustrating another method for recommending one or more first tasks to a worker on a crowdsourcing platform, in accordance with at least one embodiment; and

FIGS. 5A and 5B illustrate example user interfaces, which may be presented on a worker's computing device, in accordance with at least one embodiment.

### DETAILED DESCRIPTION

The present disclosure is best understood with reference to the detailed figures and description set forth herein. Various embodiments are discussed below with reference to the figures. However, those skilled in the art will readily appreciate that the detailed descriptions given herein with respect to the figures are simply for explanatory purposes as the methods and systems may extend beyond the described embodiments. For example, the teachings presented and the needs of a particular application may yield multiple alternate and suitable approaches to implement the functionality of any detail described herein. Therefore, any approach may extend beyond the particular implementation choices in the following embodiments described and shown.

References to “one embodiment”, “an embodiment”, “at least one embodiment”, “one example”, “an example”, “for example” and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in an embodiment” does not necessarily refer to the same embodiment.

Definitions: The following terms shall have, for the purposes of this application, the respective meanings set forth below.

A “computing device” refers to a device including one or more processors/microcontrollers and/or any other electronic components, or a device or a system that performs one or more operations according to one or more programming instructions/codes. Examples of the computing device may include, but are not limited to, a desktop computer, a laptop, a personal digital assistant (PDA), a mobile device, a Smartphone, a tablet computer (e.g., iPad®, and Samsung Galaxy Tab®), and the like.

“Crowdsourcing” refers to distribution of tasks and obtaining the needed services by soliciting the participation of defined groups of users. A group of users may include, for example, individuals responding to a solicitation posted on a certain website (e.g., crowdsourcing platform), such as Amazon Mechanical Turk or Crowd Flower.

A “crowdsourcing platform” refers to a business application, wherein a broad, loosely defined external group of workers, community, or organization provides solutions as outputs for any specific business processes received by the application as input. In an embodiment, the business application may be hosted online on a web portal. Various examples of the crowdsourcing platforms include, but are not limited to, Amazon Mechanical Turk or Crowd Flower.

A “crowd worker” refers to a worker or a group of workers that may perform one or more crowdsourcing tasks that generate data that contribute to a defined result, such as proofreading part of a digital version of an ancient text or analyzing a small quantum of a large volume of data. Hereinafter, “worker”, “crowdsourced workforce”, “crowd worker”, “crowd workforce”, and “crowd” may be interchangeably used.

A “task” refers to a project, service and/or job that may be performed by a crowdworker. A task may include instructions about how to perform the task. Further, a task may have associated task features. Examples of the task features may include, but are not limited to, a day of submitting the task, a time in the day of submitting the task, a cost of the task, and so forth. Further, a task may comprise data that may be processed by the workers. The data may correspond to an image data or a text data in an analog form and/or a digital form retained in at least one of an electronic form or a printed form. Each of the electronic form or the printed form may include one or more images, symbols, text, line art, blank, or non-printed regions etc. In an embodiment, the electronic data may be obtained by scanning a corresponding printed document containing the electronic data. Further, the electronic data may be stored in various file formats, such as, JPG or JPEG, GIF, TIFF, PNG, BMP, RAW, PSD, PSP, PDF, and the like. In an embodiment, the one or more tasks may comprise one or more of, but not limited to, data translation, data transcription, image tagging, article writing, website testing, data verification, logo design, business card design, ads, video, and website design.

“Outreach” is an activity of providing products and services to customers who might not otherwise have access to or who might not be aware of those products and services. For example, a worker may reach out to students in a remote area to offer them services and products being offered by the government. In an embodiment, such students may not be aware of the availability of the products and services.

“One or more first tasks” refers to one or more tasks that may be assigned to one or more workers for processing.

“One or more second tasks” refers to one or more tasks that have already been processed by one or more workers (i.e., historical tasks).

“Probability of success” is defined as a ratio of successful tasks to total number of tasks. In an embodiment, a task may be either successful or unsuccessful. In an embodiment, a task may be referred to as a successful task if a worker provides an accurate response for the task within a predetermined time period.

$${P}_{r} ( Y = 1 ) = \frac{successful tasks}{successful tasks + unsuccessful tasks} \qquad ( 1 )$$

where,

Pᵣ(Y=1): Probability of a task being a successful task.

“Probability of failure” is defined as a ratio of unsuccessful tasks to total number of tasks. In an embodiment, a task may be either successful or unsuccessful. In an embodiment, a task may be referred to as an unsuccessful task if a worker fails to provide an accurate response for the task within a predetermined time period.

$${P}_{r} ( Y = 0 ) = \frac{un successful tasks}{successful tasks + unsuccessful tasks} \qquad ( 2 )$$

where,

Pᵣ(Y=0): Probability of a task being an unsuccessful task.

An “organization” refers to an entity comprising a group of individuals engaged in a business of selling products/services to one or more other organizations or individuals.

An “industry” refers to a group of organizations engaged in a particular type of commercial activity by offering products and services to a particular group of customers. Examples of various industries include, but are not limited to, Health Care, Banking, Finance & Insurance, Construction, Transportation & Warehousing, Accommodation & Food Services, Retailing, Professional Consultation, Public Administration, and the like.

A “customer” refers to an individual/organization who/which purchases a product/service for self-use or for use by others. In an embodiment, an end user of a product/service may also correspond to a customer, even though the end user may or may not have purchased the product/service. In an embodiment, an end user may correspond to a direct/indirect user of the product/service.

“Transaction” refers to an exchange or a transfer of goods, services, funds, or messages between two or more entities such as between an organization and a worker, or between two or more organizations. In an embodiment, a count of transactions comprises at least one of count of checks, count of payments, count of messages, and count of packages. In an embodiment, the count of transaction associated with the one or more first tasks is an expected number of transactions that may take place between one or more industries and one or more customers associated with the one or more industries. In an embodiment, the count of transactions associated with the one or more second tasks is an actual number of transactions that have already taken place between the one or more industries and the one or more customers associated with the one or more industries.

“Location” refers to a geographical area such as a region, a country, a state, a county, a city, a town, a village, a district, or a locality. In an embodiment, the location may be associated with at least an industry, an organization, or a worker.

“First score” refers to a numerical value associated with the one or more first tasks, which may be indicative of a count of transactions between one or more industries and one or more customers based on a result of the one or more second tasks.

“Second score” refers to a numerical value associated with one or more locations for the one or more first tasks. In an embodiment, the second score may be determined for each of the one or more first tasks based on a result of the one or more second tasks in each of the one or more locations.

“Third score” to a numerical value associated with one or more industries for the one or more first tasks. In an embodiment, the third score may be determined for each of the one or more first tasks based on a result of the one or more second tasks for each of the one or more industries.

“Attributes associated with one or more tasks” refers to one or more parameters associated with the one or more tasks such as, but not limited to, one or more industries associated with the one or more tasks, a count of transactions between the one or more industries and one or more customers associated with the one or more industries, and one or more locations of the one or more industries.

“Rank score” refers to a numerical value associated with each of the one or more first tasks, which may be utilized to rank the one or more first tasks. In an embodiment, a predefined number of ranked one or more first tasks may be recommended to one or more workers. In an embodiment, the rank score may be determined based on at least the first score, the second score, the third score, and the attributes associated with the one or more first tasks.

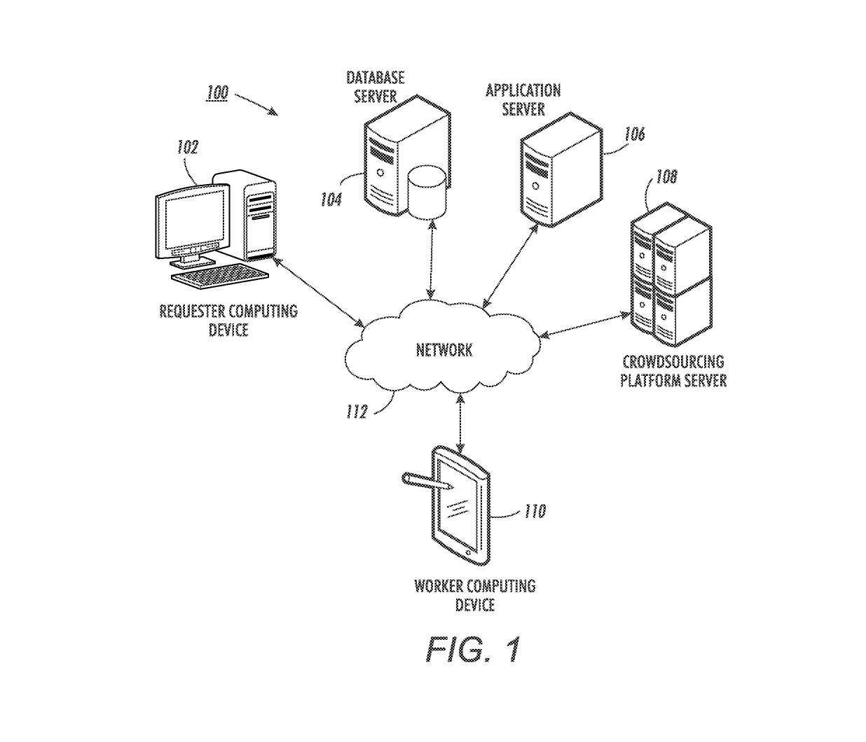

FIG. 1 is a block diagram illustrating a system environment 100 in which various embodiments may be implemented. The system environment 100 includes a requester-computing device 102, a database server 104, an application server 106, a crowdsourcing platform server 108, a worker-computing device 110, and a network 112. Various devices in the system environment 100 may be interconnected over the network 112. FIG. 1 shows, for simplicity, one worker-computing device 110, one requester-computing device 102, one database server 104, one application server 106, and one crowdsourcing platform server 108. However, it will be apparent to a person having ordinary skill in the art that the disclosed embodiments may also be implemented using multiple worker-computing devices 110, multiple requester-computing devices 102, multiple database servers 104, multiple applications servers 106, and multiple crowdsourcing platform servers 108.

The requester-computing device 102 refers to a computing device used by a requester. The requester-computing device 102 may be operable to execute one or more sets of instructions stored in one or more memories. In an embodiment, the requester-computing device 102 may be communicatively coupled over the network 112. In an embodiment, the requester may utilize the requester-computing device 102 to transmit or receive information pertaining to one or more first tasks to/from the crowdsourcing platform server 108 over the network 112. The requester may utilize the requester-computing device 102 to transmit the one or more first tasks. For example, if the crowdsourcing task corresponds to the tagging of one or more images, the requester may transmit, using the requester-computing device 102, the one or more images that are required to be tagged. In an embodiment, the information associated with the one or more first tasks may comprise, but not limited to, one or more instructions for performing the one or more first tasks, time line for completing the one or more tasks, and number of tasks required to be delivered to emails of the one or more workers. In an embodiment, where the one or more first tasks correspond to outreach tasks, the information may further include information related to one or more industries associated with the one or more first tasks, and one or more locations of the one or more industries. In an embodiment, the requester may provide the number of expected transactions between the one or more industries and one or more customers associated with the one or more industries for each of the one or more first tasks. In an embodiment, the requester may receive responses pertaining to the one or more first tasks on the requester-computing device 102 through the crowdsourcing platform over the network 112.

The requester-computing device 102 may be implemented using various types of computing devices such as, but not limited to, a desktop computer, a laptop, a personal digital assistant (PDA), a mobile device, a Smartphone, a tablet computer (for example, iPad® and Samsung Galaxy Tab®), and the like.

A person having ordinary skill in the art would understand that the requester-computing device 102 may present a graphical user interface (GUI) to the requester, which enables the requester to upload the one or more first tasks. Further, the GUI may present appropriate input box for inputting the information pertaining to the one or more first tasks.

The database server 104 may refer to a computing device that may store the tasks and corresponding information, in accordance with at least one embodiment. The tasks may comprise one or more first tasks and one or more second tasks. In an embodiment, the database server 104 may be communicatively coupled with the network 112. In an embodiment, the database server 104 may store information, such as historical data pertaining to the execution of the one or more second tasks. The historical data may comprise, but is not limited to, results/responses of the one or more second tasks, one or more industries associated with the one or more second tasks, the number of transactions between the one or more industries and the one or more customers associated with the one or more industries, and the one or more locations of the one or more industries. In an embodiment, the database server 104 may store information pertaining to the one or more first tasks. The information pertaining to the one or more first tasks may comprise, but is not limited to, one or more industries associated with the one or more first tasks, one or more locations associated with one or more industries and number of expected transactions between the one or more industries and the one or more customers associated with the one or more industries. In an embodiment, the database server 104 may further store information pertaining to the one or more workers. The information pertaining to the one or more workers may comprise, but is not limited to, name, age, qualification, working experience, educational background, employment details, number of successful tasks and number of unsuccessful tasks attempted and/or completed by the one or more workers, and an industry associated with each of the one or more workers. In an embodiment, the database server 104 may obtain the information from various sources such as, but not limited to, crowdsourcing platforms, and databases of various organizations that may provide the rightful authentication to access the information pertaining to the one or more workers. In an embodiment, the database server 104 may store the results/responses pertaining to the one or more first tasks.

Further, in an embodiment, the database server 104 may be configured to transmit or receive one or more instructions/tasks/information/features to/from one or more devices, such as the requester-computing device 102, the application server 106, the crowdsourcing platform server 108, and the worker-computing device 110 over the network 112. In an embodiment, the database server 104 may receive a query from the application server 106 or the crowdsourcing platform server 108 to retrieve the data pertaining to the one or more first tasks, the one or more second tasks, and/or the information pertaining to the one or more workers. For querying the database server 104, one or more querying languages may be utilized such as, but are not limited to, SQL, QUEL, DMX and so like. Further, the database server 104 may be realized through various technologies such as, but not limited to, Microsoft® SQL server, Oracle, and My SQL.

The application server 106 may refer to a computing device or a software framework that may provide a generalized approach to create the application-server implementation. In an embodiment, the function of the application server 106 may be dedicated to the efficient execution of procedures such as, but not limited to, programs, routines, codes or scripts stored in one or more memories for supporting its applied applications. In an embodiment, the application server 106 may extract the information pertaining to the one or more first tasks from the database server 104 and/or the crowdsourcing platform server 108. In an embodiment, the application server 106 may extract the information pertaining to the one or more second tasks from the crowdsourcing platform server 108 and/or database server 104. In an embodiment, the application server 106 may extract the information pertaining to the one or more workers from the database server 104 and/or the crowdsourcing platform server 108. In an embodiment, the requester may access the application server 106 over the network 112 to submit the information (e.g., through a web-based interface) pertaining to the one or more first tasks. In addition, the application server 106 may use the one or more instructions/codes/algorithms/programs to extract the industry code of the one or more industries associated with the one or more second tasks. For example, the industry code may be extracted using an industrial classification system, such as North American Industrial Classification System (NAICS). In an embodiment, the application server 106 may utilize Java Robot to mimic activities of workers inputting and submitting queries through a web browser. The keywords for searching the industrial code of the one or more industries may comprise, but is not limited to, a name and a state of the requester.

Further, in an embodiment, the application server 106 may utilize the one or more instructions/codes/algorithms/programs stored in the one or more memories to compute one or more scores such as a first score, a second score, a third score, a fourth score, a fifth score, and a rank score for each of the one or more first tasks. In an embodiment, the application server 106 may be operable to determine a general ranking and/or a personalized ranking of the one or more first tasks. In an embodiment, the application server 106 may recommend the one or more first tasks based on the ranking to one or more workers (through the one or more crowdsourcing platforms, such as the crowdsourcing platform server 108). In an embodiment, the application server 106 may transmit one or more links associated with the one or more first tasks based on the ranking through an e-mail to the one or more workers.

The application server 106 may be realized using various technologies such as, but not limited to, Java application server, .NET Framework, PHP, Base4 application server, and Appaserver.

A person skilled in the art would understand that the scope of the disclosure should not be limited to the database server 104 or the application server 106 as a separate entity. In an embodiment, the functionalities of the database server 104 and the application server 106 may be combined into a single server, without limiting the scope of the disclosure.

The crowdsourcing platform server 108 may refer to a computing device that may host one or more crowdsourcing platforms. In an embodiment, the one or more workers may be associated with the crowdsourcing platform server 108 over the network 112. In an embodiment, the crowdsourcing platform server 108 may present a user interface (UI) to the one or more workers through a web based interface or a client application installed on the worker-computing device 110. In an embodiment, the crowdsourcing platform server 108 may receive the one or more first tasks from the database server 104 and/or the application server 106 over the network 112. The crowdsourcing platform server 108 may transmit/display a recommended list of the one or more first tasks to the one or more workers. The one or more workers may access the one or more first tasks through the web based interface or the client application. In an embodiment, the one or more workers may submit a final task/product/response of each of the one or more first tasks to the crowdsourcing platform server 108 over the network 112.

The crowdsourcing platform servers 108 may be realized through an application server such as, but not limited to, Java application server, .NET framework, Base4 application server, and Appaserver.

A person skilled in the art would understand that the scope of the disclosure should not be limited to the database server 104, the application server 106, or the crowdsourcing platform server 108 as a separate entity. In an embodiment, the functionalities of the database server 104, the application server 106, and/or the crowdsourcing platform server 108 may be combined into a single server, without limiting the scope of the disclosure. In an alternate embodiment, the functionalities of the database server 104 and the application server 106 may be integrated into the crowdsourcing platform server 108.

The worker-computing device 110 may refer to a computing device used by a worker. The worker-computing device 110 may enable the worker to perform/work upon the one or more first tasks. In an embodiment, the worker-computing device 110 may be communicatively coupled to the network 112. In an embodiment, the worker may utilize the worker-computing device 110 to select the one or more first tasks from the displayed and/or the recommended list of the one or more first tasks. In an embodiment, the worker may utilize the worker-computing device 110 to go directly to the specific page of the one or more first tasks by clicking on the recommended list. In an embodiment, the worker may utilize the worker-computing device 110 to submit the responses pertaining to the execution of the one or more first tasks to the crowdsourcing platform over the network 112. The worker-computing device 110 may submit the responses of the one or more first tasks using the web interface (provided by the crowdsourcing platform server 108) or using the client application, as discussed above.

The worker-computing device 110 may include various types of computing devices such as, but not limited to, a desktop computer, a laptop, a personal digital assistant (PDA), a mobile device, a Smartphone, a tablet computer (e.g., iPad® and Samsung Galaxy Tab®), and the like.

The network 112 corresponds to a medium through which content and messages may flow between one or more of, but not limited to, the requester-computing device 102, the database server 104, the application server 106, the crowdsourcing platform server 108, and/or the worker-computing device 110. Examples of the network 112 may include, but are not limited to, a Wireless Fidelity (Wi-Fi) network, a Wide Area Network (WAN), a Local Area Network (LAN), or a Metropolitan Area Network (MAN). Various devices such as the requester-computing device 102, the database server 104, the application server 106, the crowdsourcing platform server 108, and/or the worker-computing device 110 may connect to the network 112 in accordance with various wired and wireless communication protocols such as Transmission Control Protocol/Internet Protocol (TCP/IP), User Datagram Protocol (UDP), and 2G, 3G, or 4G communication protocols.

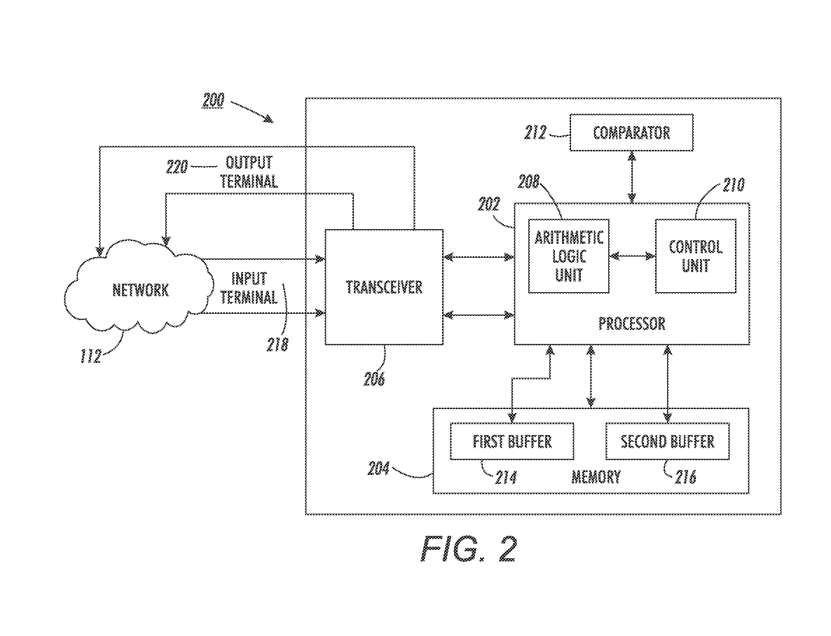

FIG. 2 is a block diagram illustrating a system 200 for recommending the one or more first tasks to the one or more workers, in accordance with at least one embodiment. The system 200 may comprise one or more processors, such as a processor 202, one or more memories, such as a memory 204, one or more transceivers, such as a transceiver 206, one or more arithmetic logic units, such as an arithmetic logic unit (ALU) 208, one or more control units, such as a control unit 210, and one or more comparators, such as a comparator 212. The memory 204 comprises at least a first buffer 214 and a second buffer 216. The transceiver 206 is coupled to an input terminal 218 and an output terminal 220.

In an embodiment, the system 200 may correspond to the application server 106 or the crowdsourcing platform server 108 without departing from the scope of the disclosure. For the purpose of the ongoing description, the system 200 has been considered as the application server 106.

The processor 202 may be operable to execute a set of instructions stored in the memory 204. The processor 202 may be coupled to the memory 204 and the transceiver 206. The processor 202 may comprise the arithmetic logic unit 208 and the control unit 210. The arithmetic logic unit 208 may be coupled to the control unit 210. In an embodiment, the control unit 210 may control the operation of the arithmetic logic unit 208. The processor 202 may execute a set of instructions/programs stored in the memory 204 to perform one or more operations. The processor 202 may be implemented based on a number of processor technologies known in the art. Examples of the processor 202 include, but are not limited to, an X86-based processor, a Reduced Instruction Set Computing (RISC) processor, an Application-Specific Integrated Circuit (ASIC) processor, and/or a Complex Instruction Set Computing (CISC) processor.

The memory 204 may be operable to store one or more machine codes, and/or computer programs having at least one code section executable by the processor 202. The memory 204 may store one or more sets of instructions and data. In an embodiment, the memory 204 may comprise one or more buffers such as the first buffer 214 and the second buffer 216. The first buffer 214 may store the one or more first tasks and the information associated with the one or more first tasks. The second buffer 216 may store the one or more second tasks and the information associated with the one or more second tasks. Some of the commonly known memory implementations include, but are not limited to, a random access memory (RAM), a read only memory (ROM), a hard disk drive (HDD), and a secure digital (SD) card. In an embodiment, the memory 204 may include the one or more machine codes, and/or computer programs that are executable by the processor 202 to perform specific operations. It will be apparent to a person having ordinary skill in the art that the one or more instructions stored in the memory 204 enables the hardware of the system 200 to perform the predetermined operation.

The transceiver 206 may be operable to communicate with the one or more devices, such as the requester-computing device 102, and/or one or more servers, such as the database server 104 over the network 112. The transceiver 206 may be operable to transmit and receive the one or more tasks to/from various components of the system environment 100. In an embodiment, the transceiver 206 is coupled to the input terminal 218 and the output terminal 220 through which the transceiver 206 may receive and transmit data/messages respectively. The transceiver 206 may be operable to transmit and receive one or more tasks to/from various components of the system environment 100. Examples of the transceiver 206 may include, but are not limited to, an antenna, an Ethernet port, an USB port or any other port that can be configured to receive and transmit data. The transceiver 206 may transmit and receive tasks in accordance with various communication protocols such as TCP/IP, UDP, and 2G, 3G, or 4G communication protocols. In operation, the transceiver 206 may receive the one or more first tasks from the requester-computing device 102 through the input terminal 218. Further, the transceiver 206 may receive the historical data pertaining to the execution of the one or more second tasks from the database server 104 through the input terminal 218. The one or more first tasks may then be stored in the first buffer 214, while the one or more second tasks may be stored in the second buffer 216. Further, the transceiver 206 may transmit the recommended list of the one or more first tasks to the worker-computing device 102 through the output terminal 220.

The comparator 212 is configured to compare at least two input signals to generate an output signal. In an embodiment, the output signal may correspond to either ‘1’ or ‘0’. In an embodiment, the comparator 212 may generate output ‘1’ if the value of a first signal (from the at least two signals) is greater than a value of the second signal (from the at least two signals). Similarly, the comparator 212 may generate an output ‘0’ if the value of the first signal is less than the value of the second signal. In an embodiment, the comparator 212 may be realized through either software technologies or hardware technologies known in the art. Though, the comparator 212 is shown outside the processor 202 in FIG. 2, a person skilled in the art would appreciate that the comparator 212 may be implemented inside the processor 202 without departing from the scope of the disclosure.

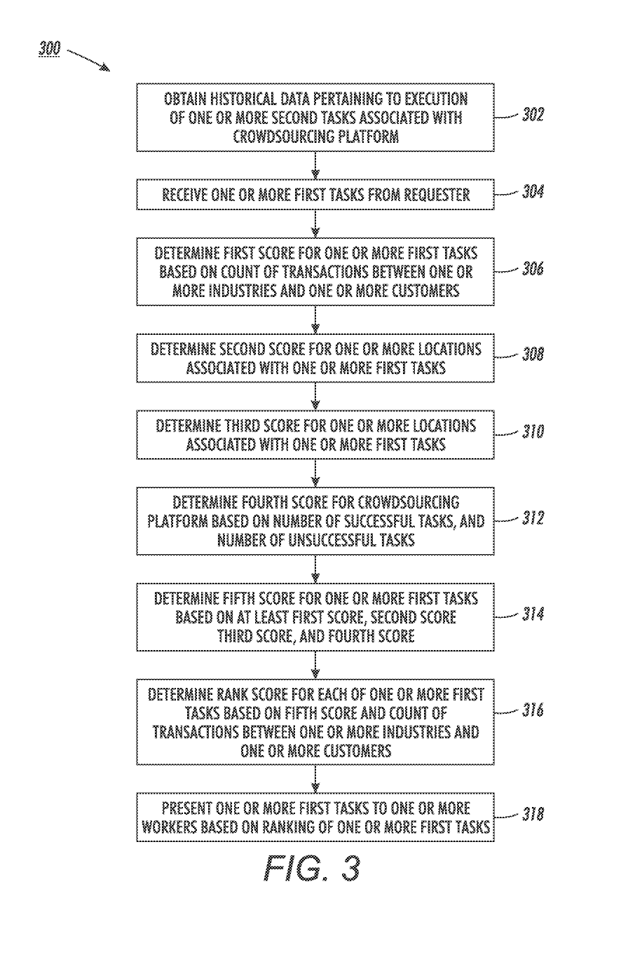

FIG. 3 is a flowchart 300 illustrating a method for recommending the one or more first tasks to the one or more workers on the crowdsourcing platform, in accordance with at least one embodiment. The flowchart 300 is described in conjunction with FIG. 1 and FIG. 2.

At step 302, the historical data pertaining to the execution of the one or more second tasks associated with the crowdsourcing platform are obtained. In an embodiment, the processor 202 may extract the historical data pertaining to the execution of the one or more second tasks associated with the crowdsourcing platform by sending a query to the database server 104. In an embodiment, the query is transmitted using the transceiver 206. The transceiver 206 may further receive the historical data from the database server 104. The historical data may comprise, but is not limited to, results of the one or more second tasks, the one or more industries associated with the one or more second tasks, the count of transactions between the one or more industries and the one or more customers associated with the one or more industries, and the one or more locations of the one or more industries. In an embodiment, the processor 202 may store the one or more second tasks and the information associated with the one or more second tasks in the second buffer 216. In an embodiment, the processor 202 may extract the information pertaining to the one or more workers from the database server 104 or the crowdsourcing platform server 108 over the network 112. The information pertaining to the one or more workers may comprise, but is not limited to, work experience of the one or more workers, and the number of successful tasks and the number of unsuccessful tasks associated with each of the one or more workers.

At step 304, the one or more first tasks are received from the requester-computing device 102. In an embodiment, the processor 202 may receive the one or more first tasks through the transceiver 206. In an embodiment, the processor 202 may further receive the information pertaining to the one or more first tasks from the requester-computing device 102. In an embodiment, the information associated with the one or more first tasks includes, but is not limited to, the one or more industries associated with the one or more first tasks, the count of expected transactions between the one or more industries and the one or more customers associated with the one or more industries, and the one or more locations of the one or more industries associated with the one or more first tasks. In an embodiment, the processor 202 may store the one or more first tasks and the information associated with the one or more first tasks in the first buffer 214.

At step 306, a first score is determined for the one or more first tasks based on the count of transactions between the one or more industries and the one or more customers. In an embodiment, the ALU 208 may determine the first score for the one or more first tasks. In an embodiment, the processor 202 may access the second buffer 216 to extract the historical data pertaining to the one or more second tasks. As discussed above, the historical data of the one or more second tasks may include the information pertaining to the count of transaction between the one or more industries and the one or more customers.

For example, the one or more second tasks may have included a task in which the worker (who processed the task) may have outreached a customer for an oil company. The task was successful and the volume of gas/oil bought by the customer was 45 Barrels. Then, 45 Barrels is the count of transaction. Similarly, the processor 202 may determine the count of transaction for each of the one or more second tasks. In an embodiment, the processor 202 may determine the range of the count of transactions throughout the one or more second tasks. For instance, the processor 202 may determine that the minimum count of transactions between an industry and a customer is 2 and the maximum of count of transactions between an industry and the customer is 100. The processor 202 may determine the range as 2-100.

In an embodiment, the processor 202 may discretize the range of the count of transactions. For example, the processor 202 may discretize the count of transactions to create the one or more categories, as shown in Table 1.

TABLE 1
An example categorization of count of transactions

Count of transactions

| | 1~31 | 32~47 | 48~88 | 89~ |
|---|---|---|---|---|
| Value of F1 | F1 = 1 | F1 = 2 | F1 = 3 | F1 = 4 |

Additionally, the processor 202 may categorize the one or more second tasks as either a successful task or an unsuccessful task (determined from the historical data). Thereafter, the processor 202 may further categorize the tasks in the unsuccessful task category and the successful task category in the one or more categories defined in the Table 1 based on the count of transactions associated with the one or more second tasks (in both the successful task category and the unsuccessful task category). The processor 202 may further determine the count of tasks in each of the one or more categories. Table 2 illustrates the count of tasks in each of the one or more categories:

TABLE 2
An example categorization of the one or more second
tasks based on the count of transaction

| | Discrete one or | | |
|---|---|---|---|
| | more categories | | |
| Y = 1(successful task)/Y = 0 | (refer Table 1) | Count of | Conditional |
| (unsuccessful tasks) | (F1) | tasks | probability |
| Y = 1 | 1 | 8 + 1 = 9 | 0.45 |
| (Successful second task) | 2 | 0 + 1 = 1 | 0.05 |
| | 3 | 2 + 1 = 3 | 0.15 |
| | 4 | 6 + 1 = 7 | 0.35 |
| | Sum | 20 | 1 |
| Y = 0 | 1 | 2 + 1 = 3 | 0.3 |
| (unsuccessful second task) | 2 | 0 + 1 = 1 | 0.1 |
| | 3 | 2 + 1 = 3 | 0.3 |
| | 4 | 2 + 1 = 3 | 0.3 |
| | Sum | 10 | 1 |

A person having ordinary skill in the art would understand that “1” is added to the count of tasks for the purpose of smoothening the count. In an embodiment, any positive integer may be utilized for the purpose of smoothening the count. In another embodiment, the count may not be smoothened.

In an embodiment, the ALU 208 may determine a conditional probability of number of transactions given a task is either successful or unsuccessful. For instance, the conditional probability that the number of transactions will lie in the range of 1-31 for a successful task is 9/20 (i.e., 0.45). Similarly, the conditional probability that the number of transactions will lie in the range of 1-31 for an unsuccessful task is 3/10 (i.e., 0.3).

After determining the conditional probability, the processor 202 extracts the information pertaining to the number of expected transactions associated with each of the one or more first tasks. Thereafter, the processor 202 determines the one or more categories for each of the one or more first tasks based on the discretization of the count of transactions (refer Table 1). Based on the categorization, the processor 202 determines the first score for each of the one or more first tasks. In an embodiment, the ALU 208 determines the conditional probability of a first task being successful given the count of transactions. For example, the expected count of transactions associated with the first task is 43. Therefore, the first task is in the category ‘2’. Thus, the probability of the first task being successful (i.e., Y=1) given that the first task lies in category ‘2’ is 0.05. Further, the probability of the first task being unsuccessful (i.e., Y=0) given that the first task lies in category ‘2’ is 0.1.

Similarly, the processor 202 may utilize the ALU 208 to determine the first score for each of the one or more first tasks.

At step 308, a second score is determined for the one or more locations associated with the one or more first tasks based on the result of the one or more second tasks in each of the one or more locations. As discussed above, each of the one or more first tasks may correspond to an outreach job for an industry at a predetermined location. Therefore, to determine the second score, the processor 202 may extract the location information and the industry information associated with each of the one or more second tasks from the second buffer 216.

In an embodiment, the processor 202 may categorize the one or more second tasks as either a successful task or an unsuccessful task (determined from the historical data). Thereafter, the processor 202 may further categorize the tasks in the unsuccessful task category and the successful task category in the one or more categories defined in the Table 3 based on the one or more locations of the one or more industries associated with the one or more second tasks (in both the successful task category and the unsuccessful task category). The processor 202 may further determine the count of tasks in each location category for each of the successful tasks and unsuccessful tasks. Table 3 illustrates the count of tasks in each of the one or more categories:

TABLE 3
An example categorization of the one or more second
tasks based on the one or more locations

| Y = 1 (successful | Pre-defined | | |
|---|---|---|---|
| task)/Y = 0 | category of | | |
| (unsuccessful | one or more locations | | Conditional |
| tasks) | (F2) | Count of tasks | probability |
| Y = 1 | DC | 1 + 1 = 2(*1) | 0.0952 |
| (Successful | FL | 3 + 1 = 4(*1) | 0.1904 |
| second task) | ID, IL, IN | 0 + 1 = 1(*3) | 0.0476 |
| | None | 3 + 1 = 4(*3) | 0.1904 |
| | Sum | 21 | |
| Y = 0 | FL | 1 + 1 = 2(*1) | 0.2222 |
| (Unsuccessful | ID, IL, IN | 0 + 1 = 1(*3) | 0.1111 |
| second task) | DC | 1 + 1 = 2(*1) | 0.2222 |
| | None | 1 + 1 = 2(*1) | 0.2222 |
| | Sum | 9 | |

A person having ordinary skill in the art would understand that “1” is added to the count of tasks for the purpose of smoothening the count. In an embodiment, any positive integer may be utilized for the purpose of smoothening the count. In another embodiment, the count may not be smoothened.

In an embodiment, the ALU 208 may determine a conditional probability of the one or more locations associated with the one or more second tasks given a task is either successful or unsuccessful. For instance, the conditional probability that the one or more second tasks in the one or more locations such as FL (Florida) is a successful task is 4/21 (i.e., 0.1904). Similarly, the conditional probability that the one or more second tasks in the one or more locations such as FL (Florida) is a unsuccessful task is 2/9 (i.e., 0.2222).

After determining the conditional probability, the processor 202 extracts the information pertaining to the one or more locations of the one or more industries associated with each of the one or more first task. Thereafter, the processor 202 determines the second score for each of the one or more first tasks. In an embodiment, the processor 202 determines the conditional probability of a first task being successful given the location associated with the first task. For example, the location associated with a first task is FL. Thus, the probability of the first task being successful (i.e., Y=1) given that the first task is associated with the location FL is 0.1904 (refer Table 3). Further, the probability of the first task being unsuccessful (i.e., Y=0) given that the first task is associated with the location FL is 0.2222 (refer Table 3). Similarly, if the location associated with the first task is ID, IL, and IN. Thus, the probability of the first task being successful (i.e., Y=1) is 0.0476 (refer Table 3). Further, the probability of the first task being unsuccessful (i.e., Y=0) given that the first task is associated with the location ID, IL, and IN is 0.1111 (refer Table 3).

Similarly, the processor 202 may utilize the ALU 208 to determine the second score for each of the one or more first tasks.

At step 310, a third score is determined for the one or more industries associated with the one or more first tasks based on the result of the one or more second tasks for each of the one or more industries. As discussed above, each of the one or more first tasks may correspond to an outreach job at a location for a predetermined industry. Therefore, to determine the third score, the processor 202 may extract the industry information and the location information associated with each of the one or more second tasks from the second buffer 216.

In an embodiment, the processor 202 may categorize the one or more second tasks as either a successful task or an unsuccessful task (determined from the historical data). Thereafter, the processor 202 may further categorize the tasks in the unsuccessful task category and the successful task category in the one or more categories defined in the Table 4 based on the one or more industries associated with the one or more second tasks (in both the successful task category and the unsuccessful task category). The processor 202 may further determine the count of tasks in each industry category for each of the successful tasks and the unsuccessful tasks. Table 4 illustrates the count of tasks in each of the one or more categories:

TABLE 4
An example categorization of the one or more second
tasks based on the one or more industries

| Y = 1(successful | Pre-defined category | | |
|---|---|---|---|
| task)/Y = 0 | of one or more | | |
| (unsuccessful | industry codes | | Conditional |
| tasks) | (F3) | Count of tasks | probability |
| Y = 1 | 11, 21, 22 | 0 + 1 = 1(*3) | 0.1000 |
| (Successful second | 56 | 3 + 1 = 4(*1) | 0.4000 |
| task) | 62 | 2 + 1 = 3(*1) | 0.3000 |
| | Sum | 10 | |
| Y = 0 | 11, 21, 22, 23, 31 | 0 + 1 = 1(*5) | 0.1250 |
| (Unsuccessful | 56 | 1 + 1 = 2(*1) | 0.2500 |
| second task) | 62 | 0 + 1 = 1(*1) | 0.1250 |
| | Sum | 8 | |

A person having ordinary skill in the art would understand that “1” is added to the count of tasks for the purpose of smoothening the count. In an embodiment, any positive integer may be utilized for the purpose of smoothening the count. In another embodiment, the count may not be smoothened.

In an embodiment, the ALU 208 may determine a conditional probability of the one or more industries associated with the one or more second tasks given a task is either successful or unsuccessful. For instance, the conditional probability that the one or more second tasks associated with the one or more industries such as health care and social assistance (industry code 62) is a successful task is 3/10 (i.e., 0.3000). Similarly, the conditional probability that the one or more second tasks associated with the one or more industries such as health care and social assistance (industry code 62) is an unsuccessful task is ⅛ (i.e., 0.1250).

After determining the conditional probability, the processor 202 extracts the information pertaining to the one or more industries associated with each of the one or more first tasks. Thereafter, the processor 202 determines the third score for each of the one or more first tasks. In an embodiment, the processor 202 determines the conditional probability of a first task being successful given the industry associated with the first tasks. For example, the industry associated with the first task is administrative and support (industry code 56). Thus, the probability of the first task being successful (i.e., Y=1) given that the first task is associated with the industry code 56 is 0.4000 (refer table 4). Further, the probability of the first task being unsuccessful (i.e., Y=0) given that the first task is associated with the industry code 56 is 0.2500 (refer Table 4).

Similarly, the processor 202 may utilize the ALU 208 to determine the third score for each of the one or more first tasks.

At step 312, a fourth score associated with the crowdsourcing platform is determined. In an embodiment, the ALU 208 may determine the fourth score associated with the crowdsourcing platform. In an embodiment, the processor 202 may utilize the arithmetic logic unit 208 to determine the fourth score. In an embodiment, the fourth score may correspond to a probability of success of the crowdsourcing platform and/or a probability of failure of the crowdsourcing platform. In an embodiment, the processor 202 may determine the fourth score based on the number of successful tasks and the number of unsuccessful tasks associated with the crowdsourcing platform. In an embodiment, the processor 202 may send a query to the database server 104 to extract the number of successful tasks and the number of unsuccessful tasks associated with the crowdsourcing platform. The processor 202 may receive the number of successful tasks and the number of unsuccessful tasks associated with the crowdsourcing platform through the input terminal 218. In an embodiment, the processor 202 may process one or more instructions/codes/programs/algorithms to determine the probability of success of the crowdsourcing platform and the probability of failure of the crowdsourcing platform. The processor 202 may utilize the following equation to determine the probability of success of the crowdsourcing platform and the probability of failure of the crowdsourcing platform:

$${P}_{r} ( Y = 1 ) = \frac{{N}_{successful}}{{N}_{successful} + {N}_{unsuccessful}} \qquad ( 3 )$$

where,

Pᵣ(Y=1): Probability of success of the crowdsourcing platform;

N_{successful}: Number of successful tasks associated with the crowdsourcing platform; and

N_{unsuccessful}: Number of unsuccessful tasks associated with the crowdsourcing platform.

$${P}_{r} ( Y = 0 ) = \frac{{N}_{unsuccessful}}{{N}_{successful} + {N}_{unsuccessful}} \qquad ( 4 )$$

where,

Pᵣ (Y=0): Probability of failure of the crowdsourcing platform.

For example, the number of successful tasks associated with the crowdsourcing platform is 16 and the number of unsuccessful tasks associated with the crowdsourcing platform is 6. The probability of success and the probability of failure of the crowdsourcing platform is determined as:

$${P}_{r} ( Y = 1 ) = \frac{16}{16 + 6} = 0.7273$$

$${P}_{r} ( Y = 0 ) = \frac{6}{16 + 6} = 0.2727$$

A person having ordinary skill in the art would understand that the scope of the disclosure is not limited to determining the fourth score for only one crowdsourcing platform. In an embodiment, the fourth score is determined for more than one crowdsourcing platform. In such a scenario, the worker may have an option to select the crowdsourcing platform from which the worker may select the tasks.

At step 314, a fifth score is determined for the one or more first tasks. In an embodiment, the ALU 208 may determine the fifth score for each of the one or more first tasks based on at least the first score, the second score, the third score, and the fourth score associated with the one or more first tasks. In an embodiment, the fifth score may correspond to the probability of success of the one or more first tasks. In another embodiment, the fifth score may correspond to the probability of failure of the one or more first tasks. The processor 202 may utilize the following equation to determine the probability of success of the one or more first tasks and the probability of failure of the one or more first tasks:

$$\begin{matrix}{P}_{r} ( Y = 1 \vert F 1 = f 1 , F 2 = f 2 , F 3 = f 3 ) ∝ {\prod }_{i = 1}^{3} {P}_{r} ( Fi = fi \vert Y = 1 ) {P}_{r} ( Y = 1 ) & ( 5 ) \\ {P}_{r} ( Y = 1 \vert F 1 = f 1 , F 2 = f 2 , F 3 = f 3 ) = \frac{{\prod }_{i = 1}^{3} {P}_{r} ( Fi = fi \vert Y = 1 ) {P}_{r} ( Y = 1 )}{{\prod }_{i = 1}^{3} {P}_{r} ( Fi = fi \vert Y = 1 ) {P}_{r} ( Y = 1 ) + {\prod }_{i = 1}^{3} {P}_{r} ( Fi = fi \vert Y = 0 ) {P}_{r} ( Y = 0 )} & ( 6 )\end{matrix}$$

where,

Pᵣ(Y=1|F1=f1, F2=f2, F3=f3): Probability of success of the one or more first tasks;

F1: Count of transactions;

F2: Locations (represented by location code);

F3: Industries (represented by industry codes);

f1, f2, and f3: values of F1, F2, and F3, respectively.

$$\begin{matrix}{P}_{r} ( Y = 0 \vert F 1 = f 1 , F 2 = f 2 , F 3 = f 3 ) ∝ {\prod }_{i = 1}^{3} {P}_{r} ( Fi = fi \vert Y = 0 ) {P}_{r} ( Y = 0 ) & ( 7 ) \\ {P}_{r} ( Y = 0 \vert F 1 = f 1 , F 2 = f 2 , F 3 = f 3 ) = \frac{{\prod }_{i = 1}^{3} {P}_{r} ( Fi = fi \vert Y = 0 ) {P}_{r} ( Y = 0 )}{{\prod }_{i = 1}^{3} {P}_{r} ( Fi = fi \vert Y = 1 ) {P}_{r} ( Y = 1 ) + {\prod }_{i = 1}^{3} {P}_{r} ( Fi = fi \vert Y = 0 ) {P}_{r} ( Y = 0 )} & ( 8 )\end{matrix}$$

where,

Pᵣ(Y=0|F1=f1, F2=f2, F3=f3): Probability of failure of the one or more first tasks.

For example, consider a task with number of checks as 60, location as DC and industry code as 56.

$${P}_{r} ( F 1 = 3 \vert Y = 1 ) {P}_{r} ( F 2 = DC \vert Y = 1 ) {P}_{r} ( F 3 = 56 \vert Y = 1 ) {P}_{r} ( Y = 1 )$$

$$\begin{matrix}= first score * second score * third score * fourth score \\ = 0.15 * 0.0952 * 0.4 * 0.7273 = 0.004154\end{matrix}$$

$${P}_{r} ( F 1 = 3 \vert Y = 0 ) {P}_{r} ( F 2 = DC \vert Y = 0 ) {P}_{r} ( F 3 = 56 \vert Y = 0 ) {P}_{r} ( Y = 0 )$$

$$\begin{matrix}= first score * second score * third score * fourth score \\ = 0.3 * 0.2222 * 0.25 * 0.2727 = 0.004544\end{matrix}$$

Thereafter, the probability of success (fifth score) of the task is determined using equation 4 as:

$${P}_{r} ( Y = 1 \vert F 1 = 3 , F 2 = DC , F 3 = 56 ) = \frac{0.004154}{0.004154 + 0.004544} = 0.4776$$

Similarly, the processor 202 may utilize the ALU 208 to determine the fifth score for each of the one or more first tasks.

At step 316, a rank score is determined for each of the one or more first tasks. In an embodiment, the ALU 208 may determine the rank score for each of the one or more first tasks based on at least the fifth score and the count of transactions associated with the one or more first tasks. In an embodiment, the rank score is the product of the count of transactions and the fifth score associated with the one or more first tasks. The processor 202 may utilize the following equation to determine the rank score of each of the one or more first tasks:

rank_score=count of transaction*fifth score (9)

For example, the rank score of the task is determined as,

rank_score(F1=3,F2=DC,F3=56)=60*0.4776=28.656

Similarly, the processor 202 determines the rank score for each of the one or more first tasks.

At step 318, the one or more first tasks are presented to the one or more workers. In an embodiment, the processor 202 may present the one or more first tasks to the one or more workers based on the ranking of the one or more first tasks. In an embodiment, the comparator 212 may compare the rank score of a first task with each rank score of the other first tasks. The comparator 212 outputs ‘1’, when the rank score of the first task is greater than the rank score of the other first tasks. In such a scenario, the processor 202 may rank the first task above each of the other first tasks. Similarly, the processor 202 may rank each of the one or more first tasks.

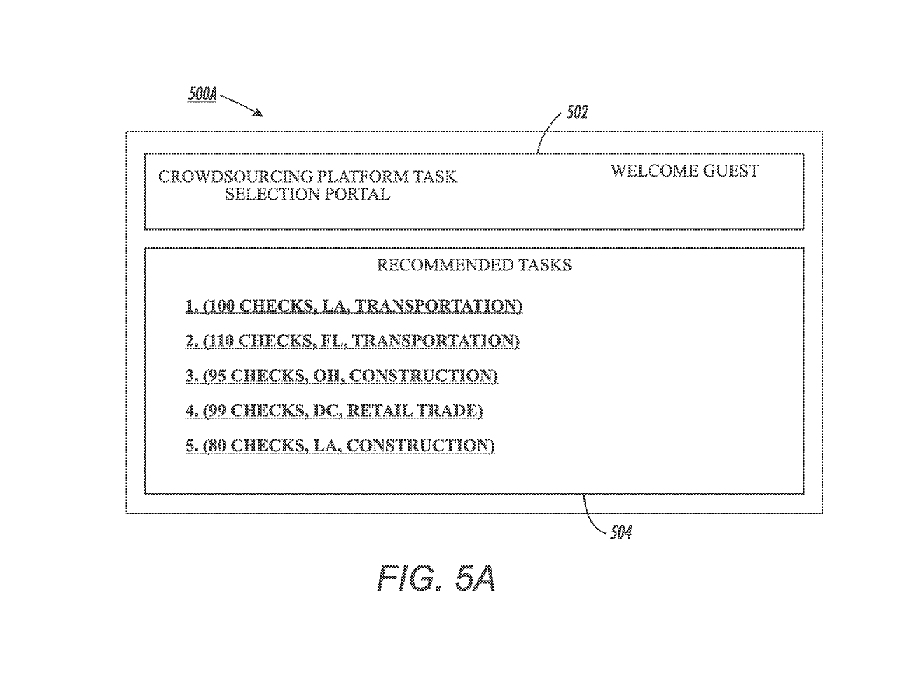

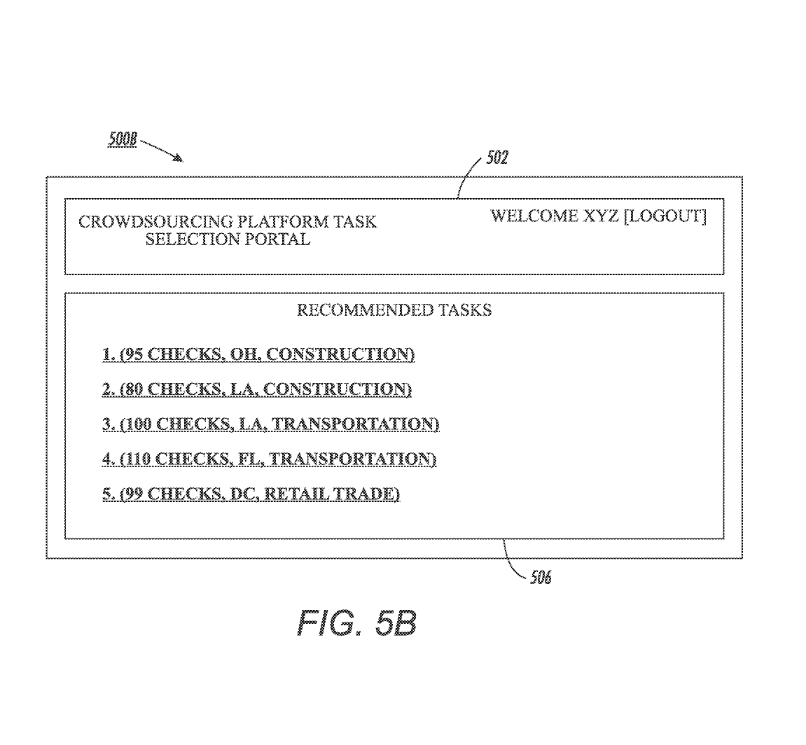

In an embodiment, the processor 202 may present the ranked one or more first tasks to the one or more workers through a user interface on the worker-computing device 110, when the worker-computing device 110 is connected to the crowdsourcing platform 108 over the network 112. In an embodiment, the processor 202 may transmit a pre-defined number of the ranked one or more first tasks through an email to the one or more workers. An example of the user-interface that may be presented to the one or more workers to display the ranked one or more first tasks is discussed in conjunction with FIG. 5A.

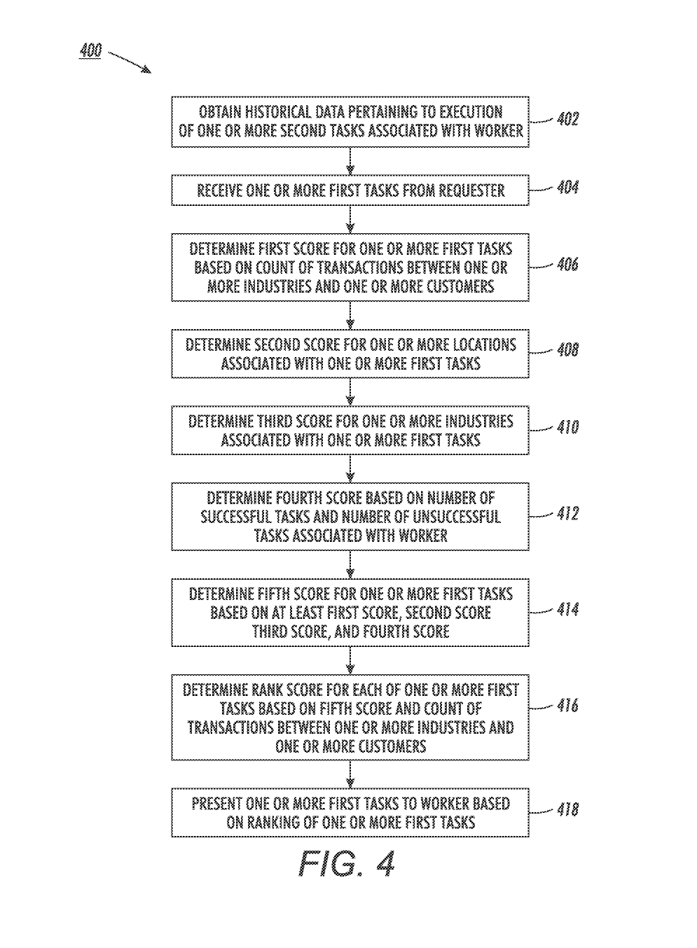

FIG. 4 is a flowchart 400 illustrating a method for recommending the one or more first tasks to a worker on a crowdsourcing platform, in accordance with at least one embodiment. The flowchart 400 is described in conjunction with FIG. 1 and FIG. 2.

At step 402, the historical data pertaining to the execution of one or more second tasks associated with the worker is obtained. In an embodiment, the processor 202 may extract the historical data pertaining to the execution of the one or more second tasks associated with the worker in the same manner as discussed above in step 302. The historical data may comprise, but is not limited to, results of the one or more second tasks associated with the worker, the one or more industries of the one or more second tasks associated with the worker, the count of transactions between the one or more industries and the one or more customers associated with the one or more industries, and the one or more locations of the one or more industries.

At step 404, the one or more first tasks are received from the requester-computing device 102. In an embodiment, the processor 202 may receive the one or more first tasks and the information associated with the one or more first tasks in the same manner as discussed above in step 304.

At step 406, a first score is determined for the one or more first tasks based on the count of transactions between the one or more industries and the one or more customers. In an embodiment, the processor 202 may categorize the one or more second tasks based on the count of transaction associated with the worker, as illustrated in Table 2. In an embodiment, the ALU 208 may determine the first score for each of the one or more first tasks in the same manner as discussed above in step 306.

At step 408, a second score is determined for the one or more locations associated with the one or more first tasks based on the result of the one or more second tasks associated with the worker in each of the one or more locations. In an embodiment, the processor 202 may categorize the one or more second tasks based on the one or more locations associated with the worker, as illustrated in Table 3. In an embodiment, the ALU 208 may determine the second score for each of the one or more first tasks in the same manner as discussed above in step 308.

At step 410, a third score is determined for the one or more industries associated with the one or more first tasks based on the result of the one or more second tasks associated with the worker in each of the one or more industries. In an embodiment, the processor 202 may categorize the one or more second tasks based on the one or more industries associated with the worker, as illustrated in Table 4. In an embodiment, the ALU 208 may determine the third score for each of the one or more first tasks in the same manner as discussed above in step 310.

At step 412, a fourth score associated with the worker is determined. In an embodiment, the ALU 208 may determine the fourth score associated with the worker. In an embodiment, the fourth score may correspond to a probability of success of the worker and/or a probability of failure of the worker. In an embodiment, the processor 202 may determine the fourth score based on the number of successful tasks and the number of unsuccessful tasks associated with the worker. In an embodiment, the ALU 208 may determine the fourth score for each of the one or more first tasks in the same manner as discussed above in step 312.

For example, the number of successful tasks associated with the worker is 8 and the number of unsuccessful tasks associated with the worker is 3. The probability of success of the worker and the probability of failure of the worker is determined as:

$${P}_{r} ( Y = 1 ) = \frac{8}{8 + 3} = 0.7273$$

$${P}_{r} ( Y = 0 ) = \frac{3}{8 + 3} = 0.2727$$

At step 414, a fifth score is determined for the one or more first tasks. In an embodiment, the ALU 208 may determine the fifth score for each of the one or more first tasks based on at least the first score, the second score, the third score, and the fourth score associated with the one or more first tasks. In an embodiment, the fifth score may correspond to the probability of success of the one or more first tasks. In another embodiment, the fifth score may correspond to the probability of failure of the one or more first tasks. In an embodiment, the ALU 208 may determine the fifth score for each of the one or more first tasks in the same manner as discussed above in step 314.

For example, consider a first task with number of checks as 60, location as FL and industry code as 56. Let the probability of the first task being successful, given the expected count of transaction (checks) as 60, as 0.20 (first score for Y=1) and the probability of the first task being unsuccessful, given the expected count of transaction (checks) as 60, as 0.40 (first score for Y=0). Let the probability of the first task being successful given that the first task is associated with the location FL is 0.2857 (second score for Y=1). Let the probability of the first task being unsuccessful given that the first task is associated with the location FL is 0.0769 (second score for Y=0). Let the probability of the first task being successful given that the first task is associated with the industry code 56 is 0.1538 (third score for Y=1). Let the probability of the first task being unsuccessful given that the first task is associated with the industry code 56 is 0.1111 (third score for Y=0).

$${P}_{r} ( F 1 = 3 \vert Y = 1 ) {P}_{r} ( F 2 = FL \vert Y = 1 ) {P}_{r} ( F 3 = 56 \vert Y = 1 ) {P}_{r} ( Y = 1 )$$

$$\begin{matrix}= first score * second score * third score * fourth score \\ = 0.20 * 0.2857 * 0.1538 * 0.7273 = 0.006391\end{matrix}$$

$${P}_{r} ( F 1 = 3 \vert Y = 0 ) {P}_{r} ( F 2 = FL \vert Y = 0 ) {P}_{r} ( F 3 = 56 \vert Y = 0 ) {P}_{r} ( Y = 0 )$$

$$\begin{matrix}= first score * second score * third score * fourth score \\ = 0.40 * 0.0769 * 0.1111 * 0.2727 = 0.0009319\end{matrix}$$

Thereafter, the probability of success (fifth score) of the first task is determined as:

$${P}_{r} ( Y = 1 \vert F 1 = 3 , F 2 = FL , F 3 = 56 ) = \frac{0.006391}{0.006391 + 0.0009319} = 0.8727$$

Similarly, the processor 202 determines the fifth score for each of the one or more first tasks.

At step 416, a rank score is determined for each of the one or more first tasks. In an embodiment, the ALU 208 may determine the rank score for each of the one or more first tasks based on the fifth score and the count of transactions. In an embodiment, the rank score is the product of the count of transactions and the fifth score associated with the one or more first tasks. For example, the rank score of the first task is determined as,

rank_score(F1=3,F2=LA,F3=56)=60*0.8727=52.362

Similarly, the processor 202 determines the rank score for each of the one or more first tasks.

At step 418, the one or more first tasks are presented to the worker. In an embodiment, the processor 202 may present the one or more first tasks to the worker based on the ranking of the one or more first tasks. In an embodiment, the comparator 212 may compare the rank score of a first tasks with each rank score of the other first tasks. The comparator 212 outputs ‘1’, when the rank score of the first task is greater than the rank score of the other first tasks. In such a scenario, the processor 202 may rank the first task above each of the other first tasks. Similarly, the processor 202 may rank each of the one or more first tasks.

In an embodiment, the processor 202 may present the ranked one or more first tasks to the worker through a user interface on the worker-computing device 110, when the worker-computing device 110 is connected to the crowdsourcing platform 108 over the network 112. In an embodiment, the processor 202 may transmit a link of a pre-defined number of ranked one or more first tasks through an email to the worker. An example of the user-interface that may be presented to the worker to display the ranked one or more first tasks is discussed in conjunction with FIG. 5B.

FIGS. 5A and 5B illustrate example user interfaces 500A and 500B respectively, which may be presented on the worker-computing device 110, in accordance with at least one embodiment.

As shown in FIG. 5A, the user interface 500A displays a crowdsourcing platform task selection portal 502 that may be presented to the one or more workers. In an embodiment, a predefined number of recommended tasks (denoted by 504) may be displayed within the crowdsourcing platform task selection portal 502. In an embodiment, the recommended tasks (denoted by 504) may correspond to the ranked list of one or more first tasks for the one or more workers, as discussed in conjunction with FIG. 3. As shown in FIG. 5A, each task may be displayed as a link whose text may be a listing of the attributes of the respective task. For example, the task 1 has the attributes 100 checks (count of transactions), LA (location), and transportation (industry). Similarly, the task 2 has the attributes 110 checks, FL, and transportation. When the one or more workers click on one of the links, the one or more workers are presented the respective task for processing.

A person skilled in the art would appreciate that the user interface 500A may be presented to the one or more workers in a scenario where the one or more workers may not have logged into the crowdsourcing platform task selection portal 502. That is, the user interface 500A may correspond to the scenario where the one or more workers are accessing the crowdsourcing platform task selection portal 502 as guest users.

As shown in FIG. 5B, the user interface 500B displays the crowdsourcing platform task selection portal 502 that may be presented to the worker. In an embodiment, a predefined number of recommended tasks (denoted by 506) may be displayed within the crowdsourcing platform task selection portal 502. In an embodiment, the recommended tasks (denoted by 506) may correspond to the ranked list of one or more first tasks for the worker, as discussed in conjunction with FIG. 4. As shown in FIG. 5B, each task may be displayed as a link whose text may be a listing of the attributes of the respective task. For example, the task 1 has the attributes 95 checks (count of transactions), OH (location), and construction (industry). Similarly, the task 2 has the attributes 80 checks, LA, and construction. When the worker clicks on one of the links, the worker is presented the respective task for processing.

A person skilled in the art would appreciate that the user interface 500B may be presented to the worker in a scenario where the worker may have logged into the crowdsourcing platform task selection portal 502.

A person having ordinary skill in the art would understand that the scope of the disclosure is not limited to displaying the one or more first tasks. In an embodiment, the rank score associated with the first tasks may also be displayed along with ranked first tasks. Similarly, the first score, the second score, the third score, the fourth score and the fifth score may also be displayed on the user interface.

Various embodiments of the disclosure lead to the recommendation of the one or more tasks to the one or more workers. Historical data related to execution of tasks by workers is analyzed across industries, locations, count of transactions between organization and their customers. Based on this analysis, a probability of success/failure of the one or more current tasks may be determined. The one or more current tasks may then be ranked based on the determined probability of success/failure. Thereafter, based on the ranking, the one or more current tasks may be recommended to the one or more workers.

The disclosed methods and systems, as illustrated in the ongoing description or any of its components, may be embodied in the form of a computer system. Typical examples of a computer system include a general-purpose computer, a programmed microprocessor, a micro-controller, a peripheral integrated circuit element, and other devices, or arrangements of devices that are capable of implementing the steps that constitute the method of the disclosure.

The computer system comprises a computer, an input device, a display unit and the Internet. The computer further comprises a microprocessor. The microprocessor is connected to a communication bus. The computer also includes a memory. The memory may be Random Access Memory (RAM) or Read Only Memory (ROM). The computer system further comprises a storage device, which may be a hard-disk drive or a removable storage drive, such as, a floppy-disk drive, optical-disk drive, and the like. The storage device may also be a means for loading computer programs or other instructions into the computer system. The computer system also includes a communication unit. The communication unit allows the computer to connect to other databases and the Internet through an input/output (I/O) interface, allowing the transfer as well as reception of data from other sources. The communication unit may include a modem, an Ethernet card, or other similar devices, which enable the computer system to connect to databases and networks, such as, LAN, MAN, WAN, and the Internet. The computer system facilitates input from a user through input devices accessible to the system through an I/O interface.

In order to process input data, the computer system executes a set of instructions that are stored in one or more storage elements. The storage elements may also hold data or other information, as desired. The storage element may be in the form of an information source or a physical memory element present in the processing machine.

The programmable or computer-readable instructions may include various commands that instruct the processing machine to perform specific tasks, such as steps that constitute the method of the disclosure. The systems and methods described can also be implemented using only software programming or using only hardware or by a varying combination of the two techniques. The disclosure is independent of the programming language and the operating system used in the computers. The instructions for the disclosure can be written in all programming languages including, but not limited to, “C,” “C++,” “Visual C++,” Java, and “Visual Basic.” Further, the software may be in the form of a collection of separate programs, a program module containing a larger program or a portion of a program module, as discussed in the ongoing description. The software may also include modular programming in the form of object-oriented programming. The processing of input data by the processing machine may be in response to user commands, the results of previous processing, or from a request made by another processing machine. The disclosure can also be implemented in various operating systems and platforms including, but not limited to, “Unix,” “DOS,” “Android,” “Symbian,” and “Linux.”

The programmable instructions can be stored and transmitted on a computer-readable medium. The disclosure can also be embodied in a computer program product comprising a computer-readable medium, or with any product capable of implementing the above methods and systems, or the numerous possible variations thereof.

Various embodiments of the methods and systems for recommending one or more tasks to one or more workers have been disclosed. However, it should be apparent to those skilled in the art that modifications in addition to those described, are possible without departing from the inventive concepts herein. The embodiments, therefore, are not restrictive, except in the spirit of the disclosure. Moreover, in interpreting the disclosure, all terms should be understood in the broadest possible manner consistent with the context. In particular, the terms “comprises” and “comprising” should be interpreted as referring to elements, components, or steps, in a non-exclusive manner, indicating that the referenced elements, components, or steps may be present, or utilized, or combined with other elements, components, or steps that are not expressly referenced.

A person having ordinary skills in the art will appreciate that the system, modules, and sub-modules have been illustrated and explained to serve as examples and should not be considered limiting in any manner. It will be further appreciated that the variants of the above disclosed system elements, or modules and other features and functions, or alternatives thereof, may be combined to create other different systems or applications.

Those skilled in the art will appreciate that any of the aforementioned steps and/or system modules may be suitably replaced, reordered, or removed, and additional steps and/or system modules may be inserted, depending on the needs of a particular application. In addition, the systems of the aforementioned embodiments may be implemented using a wide variety of suitable processes and system modules and is not limited to any particular computer hardware, software, middleware, firmware, microcode, or the like.

The claims can encompass embodiments for hardware, software, or a combination thereof.

It will be appreciated that variants of the above disclosed, and other features and functions or alternatives thereof, may be combined into many other different systems or applications. Presently unforeseen or unanticipated alternatives, modifications, variations, or improvements therein may be subsequently made by those skilled in the art, which are also intended to be encompassed by the following claims.

What is claimed is:

1. A method for recommending one or more first tasks to one or more workers, said method comprising:
obtaining, by one or more processors, historical data pertaining to execution of one or more second tasks associated with a crowdsourcing platform, wherein said historical data comprises a result of said one or more second tasks, one or more industries associated with said one or more second tasks, a count of transactions between said one or more industries and one or more customers associated with said one or more industries, and one or more locations of said one or more industries;
determining, by an arithmetic logic unit in said one or more processors, a first score for said count of transactions between said one or more industries and said one or more customers based on said result of said one or more second tasks;
determining, by said arithmetic logic unit in said one or more processors, a second score for each of said one or more locations based on said result of said one or more second tasks in said each of said one or more locations;
determining, by said arithmetic logic unit in said one or more processors, a third score for each of said one or more industries based on said result of said one or more second tasks in said each of said one or more industries; and
ranking, by said one or more processors, said one or more first tasks based on at least said first score, said second score, said third score, and one or more attributes associated with said one or more first tasks, wherein said ranked one or more first tasks are presented to said one or more workers.

2. The method of claim 1, wherein said result of said one or more second tasks comprises at least one of successful tasks, or unsuccessful tasks.

3. The method of claim 1, wherein said count of transactions comprises at least one of count of checks, count of payments, count of messages, and count of packages.

4. The method of claim 2 further comprising determining, by said arithmetic logic unit in said one or more processors, a fourth score for said crowdsourcing platform based on a number of said successful tasks, and a number of said unsuccessful tasks associated with said crowdsourcing platform.

5. The method of claim 2 further comprising determining, by said arithmetic logic unit in said one or more processors, a fifth score for said one or more first tasks based on at least said first score, said second score, said third score, said fourth score, and said one or more attributes associated with said one or more first tasks.

6. The method of claim 5, wherein said one or more attributes comprises said count of transactions between said one or more industries and said one or more customers associated with said one or more industries, said one or more locations of said one or more industries, and said one or more industries associated with said one or more first tasks.

7. The method of claim 6 further comprising determining, by said arithmetic logic unit in said one or more processors, a rank score for said one or more first tasks based on at least said fifth score and said count of transactions between said one or more industries and said one or more customers associated with said one or more industries, wherein said one or more first tasks are ranked based on said rank score.

8. A method for recommending one or more first tasks to a worker, said method comprising:
obtaining, by one or more processors, historical data pertaining to execution of one or more second tasks associated with said worker, wherein said historical data comprises a result of said one or more second tasks, one or more industries associated with said one or more second tasks, a count of transactions between said one or more industries and one or more customers associated with said one or more industries, and one or more locations of said one or more industries;
determining, by an arithmetic logic unit in said one or more processors, a first score for said count of transactions between said one or more industries and said one or more customers based on said result of said one or more second tasks;
determining, by said arithmetic logic unit in said one or more processors, a second score for each of said one or more locations based on said result of said one or more second tasks in said each of said one or more locations;
determining, by said arithmetic logic unit in said one or more processors, a third score for each of said one or more industries based on said result of said one or more second tasks for each of said one or more industries; and
ranking, by said one or more processors, said one or more first tasks based on at least said first score, said second score, said third score, and one or more attributes associated with said one or more first tasks, wherein said ranked one or more first tasks are presented to said worker.

9. The method of claim 8, wherein said result of said one or more second tasks comprises at least one of successful tasks, or unsuccessful tasks.

10. The method of claim 8, wherein said count of transactions comprises at least one of count of checks, count of payments, count of messages, and count of packages.

11. The method of claim 9 further comprising determining, by said arithmetic logic unit in said one or more processors, a fourth score for said worker based on a number of said successful tasks, and a number of said unsuccessful tasks associated with said worker.

12. The method of claim 8 further comprising determining, by said arithmetic logic unit in said one or more processors, a fifth score for said one or more first tasks based on at least said first score, said second score, said third score, said fourth score, and said one or more attributes associated with said one or more first tasks.

13. The method of claim 12, wherein said one or more attributes comprises said count of transactions between said one or more industries and said one or more customers associated with said one or more industries, said one or more locations of said one or more industries, and said one or more industries associated with said one or more first tasks.

14. The method of claim 12 further comprising determining, by said arithmetic logic unit in said one or more processors, a rank score for said one or more first tasks based on at least said fifth score and said count of transactions between said one or more industries and said one or more customers associated with said one or more industries, wherein said one or more first tasks are ranked based on said rank score.

15. The method of claim 8, wherein said ranking is generated based on said historical data of a group where said worker belongs.

16. A system for recommending one or more first tasks to one or more workers, said system comprising:
one or more processors configured to:
obtain, by one or more processors, historical data pertaining to execution of one or more second tasks associated with a crowdsourcing platform, wherein said historical data comprises a result of said one or more second tasks, one or more industries associated with said one or more second tasks, a count of transactions between said one or more industries and one or more customers associated with said one or more industries, and one or more locations of said one or more industries;
determine, by an arithmetic logic unit in said one or more processors, a first score for said count of transactions between said one or more industries and said one or more customers based on said result of said one or more second tasks;
determine, by said arithmetic logic unit in said one or more processors, a second score for each of said one or more locations based on said result of said one or more second tasks in said each of said one or more locations;
determine, by said arithmetic logic unit in said one or more processors, a third score for each of said one or more industries based on said result of said one or more second tasks for each of said one or more industries;
determine, by said arithmetic logic unit in said one or more processors, a fourth score for said crowdsourcing platform based on a number of successful tasks, and a number of unsuccessful tasks associated with said crowdsourcing platform;
determine, by said arithmetic logic unit in said one or more processors, a fifth score for said one or more first tasks based on at least said first score, said second score, said third score, said fourth score, and one or more attributes associated with said one or more first tasks;
determine, by said arithmetic logic unit in said one or more processors, a rank score for said one or more first tasks based on at least said fifth score and said count of transactions between said one or more industries and said one or more customers associated with said one or more industries; and
rank, by said one or more processors, said one or more first tasks based on said rank score, wherein said ranked one or more first tasks are presented to said one or more workers.

17. A computer program product for use with a computer, the computer program product comprising a non-transitory computer readable medium, wherein the non-transitory computer readable medium stores a computer program code for recommending one or more first tasks to one or more workers, wherein the computer program code is executable by one or more processors to:
obtain, by one or more processors, historical data pertaining to execution of one or more second tasks associated with a crowdsourcing platform, wherein said historical data comprises a result of said one or more second tasks, one or more industries associated with said one or more second tasks, a count of transactions between said one or more industries and one or more customers associated with said one or more industries, and one or more locations of said one or more industries;
determine, by an arithmetic logic unit in said one or more processors, a first score for said count of transactions between said one or more industries and said one or more customers based on said result of said one or more second tasks;
determine, by said arithmetic logic unit in said one or more processors, a second score for each of said one or more locations based on said result of said one or more second tasks in said each of said one or more locations;
determine, by said arithmetic logic unit in said one or more processors, a third score for each of said one or more industries based on said result of said one or more second tasks for each of said one or more industries;
determine, by said arithmetic logic unit in said one or more processors, a fourth score for said crowdsourcing platform based on a number of successful tasks, and a number of unsuccessful tasks associated with said crowdsourcing platform;
determine, by said arithmetic logic unit in said one or more processors, a fifth score for said one or more first tasks based on at least said first score, said second score, said third score, said fourth score, and one or more attributes associated with said one or more first tasks;
determine, by said arithmetic logic unit in said one or more processors, a rank score for said one or more first tasks based on at least said fifth score and said count of transactions between said one or more industries and said one or more customers associated with said one or more industries; and
rank, by said one or more processors, said one or more first tasks based on said rank score, wherein said ranked one or more first tasks are presented to said one or more workers.
